(19) United States
(12) Patent Application Publication
(10) Pub. No.: US 2025/0385084 A1
(43) Pub. Date: Dec. 18, 2025

(54) COMPOUND MASS SPECTROMETRY ANALYSIS SYSTEM AND THE SERVER THEREOF

(71) Applicant: Agricultural Chemicals Research Institute, Ministry of Agriculture, Taichung City (TW)

(72) Inventors: Ling-Yang WANG, Taichung City (TW); Shao-Kai LIN, Taichung City (TW); Wei-Chen CHUANG, Taichung City (TW)

(21) Appl. No.: 18/949,364

(22) Filed: Nov. 15, 2024

(30) Foreign Application Priority Data
Jun. 14, 2024 (TW) 113122149

(51) Int. Cl. H01J 49/00; G01N 30/72; G01N 30/86

(52) U.S. Cl. CPC H01J 49/004; G01N 30/72; G01N 30/8631

(57) ABSTRACT

A compound mass spectrometry analysis system includes a mass spectrometer, a client computer connected to the mass spectrometer, and a server connected to the client computer. The mass spectrometer is used to test a sample solution and correspondingly generate a mass spectrometry file on the client computer. The client computer is responsible for transmitting the mass spectrometry file to the server, which contains a data reading module. This data reading module is designed to extract the name of each compound, multiple ion pairs, and all corresponding peaks from the mass spectrometry file associated with the sample solution.

### FIELD OF INVENTION

The present invention relates to mass spectrometry analysis technology, particularly to a compound mass spectrometry analysis system and its server.

### RELATED PRIOR ART

The compounds present in a sample, such as the pesticide residues in a vegetable sample, can be detected using a mass spectrometer. Common mass spectrometers include a Liquid Chromatography Tandem Mass Spectrometer (LC-MS/MS) and a Gas Chromatography Tandem Mass Spectrometer (GC-MS/MS).

A bottleneck in current compound detection operations is that the mass spectrometry file produced by the mass spectrometer requires experienced examiners to spend a significant amount of manpower and time analyzing it in order to obtain the characteristic peak data of each compound in the file (such as the total area and signal-to-noise ratio of the quantitative or qualitative characteristic peak for each compound). This not only results in inefficient overall compound detection operations but also increases the likelihood of errors due to human oversight. Additionally, it takes 2 to 3 years to train examiners capable of performing such operations independently, leading to frequent shortages of qualified examiners.

### SUMMARY OF THE INVENTION

The present invention provides a compound mass spectrometry analysis system, which includes a mass spectrometer, a client computer coupled to the mass spectrometer, and a server coupled to the client computer; the mass spectrometer is used to analyze a test solution and generate a corresponding mass spectrometry file on the client computer; the client computer is used to transmit the mass spectrometry file to the server; the server includes a reading module, wherein the reading module is used to read multiple ion pairs of each compound contained in the test solution and all corresponding peaks of each ion pair from the mass spectrometry file.

In one embodiment, the server of the present invention further includes a compound list that records the names and ion pairs of multiple compounds. The reading module can query the compound list to obtain the name of each compound based on the ion pair read for each compound.

In one embodiment, the server of the present invention further includes a conversion module, which is used to perform a file format conversion operation. The file format conversion operation includes converting the file format of the mass spectrometry file received by the server into the file format required by the reading module.

In one embodiment, the present invention includes a checking module. The checking module performs a format check on the name of the mass spectrometry file received by the server before the conversion module executes the file format conversion operation and only transmits mass spectrometry files with names that conform to a specified naming format to the conversion module.

In one embodiment, the compound mass spectrometry analysis system of the present invention, wherein the server further includes a parameter table and a filtering module. The parameter table records filter parameter sets for multiple compounds, and the filtering module performs a filtering operation on the ion pairs and peaks of each compound read by the reading module based on the parameter table. The filtering operation includes: reading the filter parameter set specific to a compound from the parameter table based on the compound read by the reading module; and based on the filter parameter set specific to the compound, selecting one of the ion pairs read by the reading module as a the quantitative ion pair of the compound, and designating the remaining ion pairs as qualitative ion pairs. Preferably, the filtering operation further includes: based on the filter parameter set specific to the compound, selecting one or more peaks from all the peaks of the quantitative ion pair of the compound as one or more quantitative characteristic peaks of the quantitative ion pair. More preferably, the filtering operation further includes: based on the positions of the one or more quantitative characteristic peaks found, respectively identifying one or more peaks with same positions as the one or more quantitative characteristic peaks from all the peaks of each qualitative ion pair of the compound, and using them as the one or more qualitative characteristic peaks for each qualitative ion pair.

In one embodiment, the parameter table is created for the mass spectrometer, and the client computer of the present invention includes a collection module configured to transmit the mass spectrometry file and collection module an identification data of the client computer to the server. The filtering module is able to identify the parameter table based on the identification data.

In one embodiment, the server of the present invention further includes a signal-to-noise ratio (S/N) calculation module for performing an S/N calculation operation. The S/N calculation operation comprises the following steps: capturing peaks from a period before or after the position of the quantitative or qualitative characteristic peak of the compound as a background noise based on a S/N parameter in the compound's filter parameter set, and treating the quantitative or qualitative characteristic peak as the target signal; and calculating the S/N for the quantitative or qualitative characteristic peak based on the intensity of the target signal and the intensity of the background noise. Preferably, the S/N calculation operation further comprises the following step: determining whether to check the S/N of the quantitative or qualitative characteristic peak based on an S/N judgment parameter in the compound's filter parameter set.

In one embodiment, the server of the present invention further includes an area calculation module for performing an area calculation operation, which comprises: establishing a baseline for the quantitative or qualitative characteristic peak, and calculating the total area between the quantitative or qualitative characteristic peak and the baseline, wherein the baseline is the line connecting the lowest points on both side of the quantitative or qualitative characteristic peak.

In one embodiment, the server of the present invention further includes a characteristic peak extraction module for performing an extraction operation. The extraction operation includes the following steps: obtaining all quantitative characteristic peaks of each compound acquired from the mass spectrometry file via the filtering module; obtaining the name of each compound, multiple ion pairs of each compound, and all peaks for each ion pair of each compound read from another mass spectrometry file via the reading module; and based on the positions of all quantitative characteristic peaks of each compound acquired from the mass spectrometry file, identifying peaks with the same or similar positions from all peaks of each ion pair of each compound read from the other mass spectrometry file, and designating them as quantitative characteristic peaks of each compound read from the another mass spectrometry file.

In one embodiment, the server of the present invention further includes a mass spectrum plotting module, which is used to plot a mass spectrum of each compound based on all the peaks of the quantitative ion pair and one or more qualitative ion pairs of each compound filtered by the filtering module. Each mass spectrum includes a quantitative ion pair curve and one or more qualitative ion pair curves for each compound. The mass spectrum plotting module also marks the coordinate points of the quantitative characteristic peaks and qualitative characteristic peaks of each compound on the mass spectrum based on the height and position of the quantitative and qualitative characteristic peaks of each compound filtered by the filtering module.

In one embodiment, the server of the present invention further includes a mass spectrum comparison module, which is used to compare whether the quantitative characteristic peaks (or qualitative characteristic peaks) from the mass spectrometry file is same as the quantitative characteristic peak (or qualitative characteristic peaks) from another mass spectrometry file.

The present invention also provides a server that can be the same as the server in any of the aforementioned systems.

### BRIEF DESCRIPTION OF DRAWINGS

FIG. 1 shows a functional block diagram of the compound mass spectrometry analysis system of the present invention.

FIG. 2 shows a flowchart of the execution of the filtering module in the present invention.

FIGS. 3 to 5 show mass spectra of several compounds plotted by the mass spectrum plotting module of the present invention.

FIG. 6 shows a flowchart of the execution of the signal-to-noise ratio (S/N) calculation module of the present invention.

FIG. 7 shows the characteristic peak data of several compounds generated by the server of the present invention.

FIG. 8 shows a flowchart of the execution of the characteristic peak extraction module of the present invention.

FIGS. 9 to 11 show the mass spectrum comparison charts of three compounds generated by the mass spectrometry plot generation module 37 of the present invention.

### DETAILED DESCRIPTION OF THE INVENTION

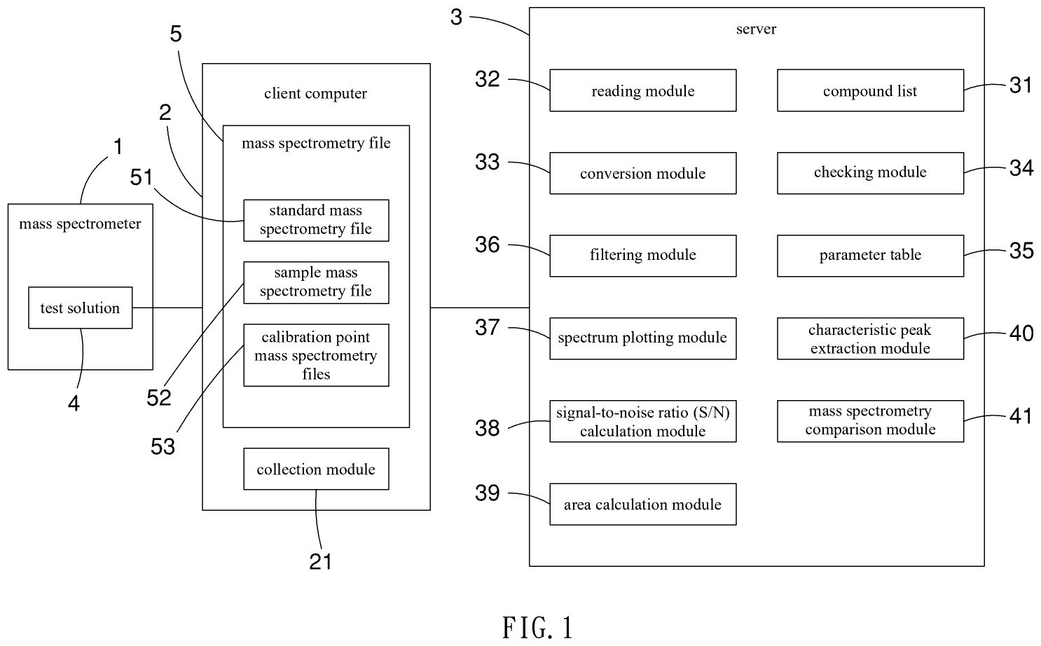

FIG. 1 shows an embodiment of the compound mass spectrometry analysis system of the present invention, which includes a mass spectrometer 1, a client computer 2 coupled to the mass spectrometer 1, and a server 3 coupled to the client computer 2. In another embodiment, the server 3 is coupled to multiple client computers 2, each of which is connected to a respective mass spectrometer 1.

The mass spectrometer 1 is used to analyze at least one test solution 4 and generate at least one corresponding mass spectrometry file 5, which is stored in a predetermined location on the client computer 2. The client computer 2 is used to transmit the mass spectrometry file 5 to the server 3. The server 3 is used to analyze the received mass spectrometry file 5.

The mass spectrometer 1 may be a liquid chromatography-tandem mass spectrometer (LC-MS/MS), a gas chromatography-tandem mass spectrometer (GC-MS/MS), or other types of mass spectrometers. The client computer 2 may be a desktop computer, a laptop, a tablet, or a smartphone. The client computer 2 can connect to the server 3 via an internal network or the internet. The server 3 typically consists of one or more server-grade computer hosts and one or more storage devices, but is not limited to this configuration.

The test solution (4) can be a solution for various purposes, such as:

A cleaning solution for cleaning the mass spectrometer (1), which contains methanol, or a mixed solvent of acetone and n-hexane.

A matrix solution for checking matrix contamination, which contains a matrix. The matrix can be an agricultural product (such as a vegetable or a fruit) or other food, but it does not contain compounds (such as pesticides).

A standard comparison solution, which contains the matrix and a standard solution with a predetermined concentration (e.g., 50 ppb). The standard solution contains one or more standard compounds, such as a pesticide standard solution containing multiple pesticide standards like abamectin and Acephate.

A calibration point solution used for creating a calibration curve, which contains the matrix and the standard solution with a predetermined concentration. According to the “Method of Test for Pesticide Residues in Foods—Multiresidue Analysis (5)” announced by Taiwan's Food and Drug Administration (under the Ministry of Health and Welfare) in 2022 (hereinafter referred to as the “announcement method”), at least five calibration point solutions with different concentrations must be prepared separately for LC/MS/MS and GC/MS/MS. The concentrations of the standard solution in these five calibration point solutions should range between 2 ppb and 200 ppb.

An instrument management solution used for creating an instrument management table, which contains the standard solution with a predetermined concentration (e.g., 50 ppb).

A quality control solution used for creating a quality control chart, which contains the matrix and the standard solution with a predetermined concentration (e.g., 10 ppb).

A repeat analysis solution used for performing a repeat analysis operation, which has the same composition as the quality control solution.

A blank solution used for checking whether the mass spectrometer 1 is contaminated, which contains pure water, without the matrix or any compounds.

A sample solution that contains a test sample. The test sample is the same as the matrix but may contain one or more compounds to be detected, such as a vegetable or fruit collected from a farm or market, but not limited to these.

The aforementioned compounds can include pesticides, veterinary drugs, or other types of chemicals. If the compounds mentioned above are pesticides, the preparation methods for various test solutions 4 mentioned can refer to the previously announcement method, which will not be elaborated here.

However, regardless of the type of test solution 4 mentioned above, once they have been tested by the mass spectrometer 1, the corresponding mass spectrometry files 5 will be generated by the mass spectrometer 1 and stored in a predetermined location on the client computer 2. For example, the mass spectrometer 1 tests a standard mass spectrometry file 51 from the standard comparison solution, the mass spectrometer 1 tests a sample mass spectrometry file 52 from the sample solution, and the mass spectrometer 1 tests multiple calibration point mass spectrometry files 53 from the calibration point solutions, etc. Once these mass spectrometry files 5 are generated, they are uploaded from the client computer 2 to the server 3 for analysis.

To detect one or more of the 410 types of pesticides covered by the announced method from the sample, multiple standard comparison solutions and multiple sample solutions need to be prepared according to the announced method, which can be injected into both LC/MS/MS and GC/MS/MS for testing. For example, an LC standard comparison solution (containing multiple pesticide standards such as Abamectin) and an LC sample solution for LC/MS/MS, and a GC standard comparison solution (containing multiple pesticide standards such as Acetochlor) and a GC sample solution for GC/MS/MS. After LC/MS/MS completes the testing of the LC standard comparison solution and the LC sample solution, it will generate an LC standard mass spectrometry file and an LC sample mass spectrometry file accordingly. Similarly, after GC/MS/MS completes the testing of the GC standard comparison solution and the GC sample solution, it will generate a GC standard mass

The client computer 2 is equipped with a collection module 21. The collection module 21 is used to transmit the mass spectrometry files 5 located at the predetermined location to the server 3. Preferably, the collection module 21 periodically queries the predetermined location on the client computer 2 and transmits any mass spectrometry files 5 that have not yet been uploaded to the server 3. However, it is also possible to manually operate the collection module 21 to send the mass spectrometry files 5 to the server 3.

Preferably, the collection module 21 on the client computer 2 can also transmit identification information (such as the IP address of the client computer 2) that represents the client computer 2 (which also corresponds to representing the mass spectrometer 1) when sending the mass spectrometry files 5 to the server 3. In a configuration where the server 3 is connected to multiple client computers 2, the collection module 21 of each client computer 2 will transmit its own identification information to the server 3, allowing the server 3 to determine which client computer 2, or correspondingly, which mass spectrometer 1, the received mass spectrometry files 5 are from based on the identification information.

The server 3 contains a compound list 31. The compound list 31 records the names and ion pairs of each compound intended to be extracted from the mass spectrometry files 5. For example, if the goal is to extract one or more of the 410 pesticides applicable under the official method from the mass spectrometry files 5, the compound list 31 must record the names and ion pairs of these 410 pesticides. Similarly, if the goal is to extract N types of veterinary drugs from the mass spectrometry files 5, the compound list 31 must record the names and ion pairs of these N veterinary drugs.

The server 3 also includes a reading module 32. For a specific mass spectrometry file 5 (e.g., the aforementioned standard mass spectrometry file 51) corresponding to a test solution 4 containing one or more compounds, the reading module 32 can extract the mass spectrometry data of each compound contained in the test solution 4 from the mass spectrometry file 5. Each mass spectrometry data set includes multiple ion pairs of a compound and all the peaks of each ion pair. However, if the test solution 4 does not contain any compounds, the reading module 32 will not be able to extract any mass spectrometry data of compounds from the mass spectrometry file 5.

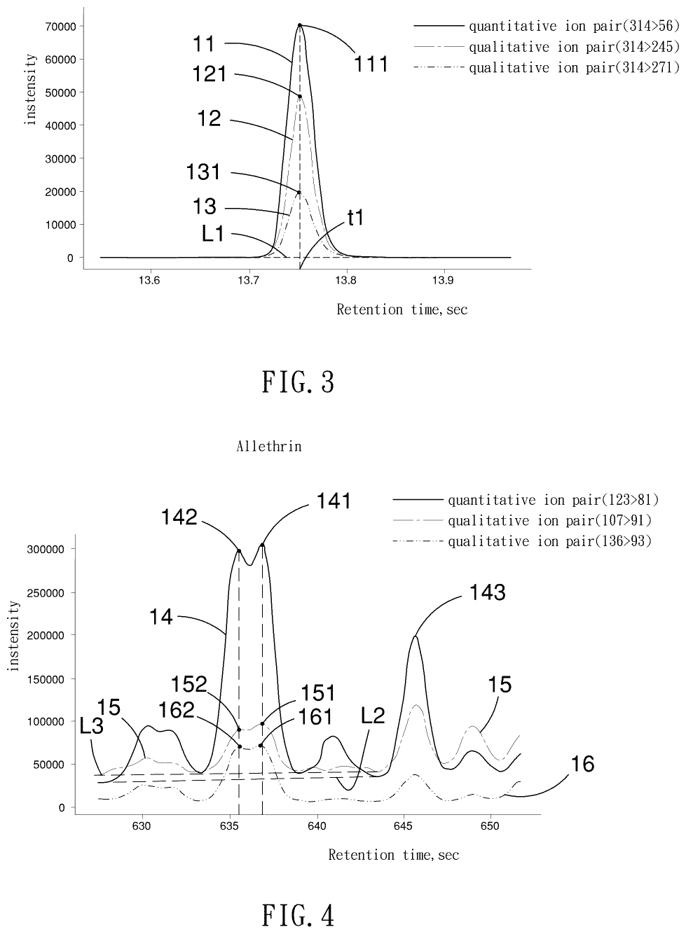

In any mass spectrometry file 5, each compound typically has two or more ion pairs, with each ion pair having multiple peaks. Each peak has a height (signal intensity, see the y-axis in FIG. 3) and a position (retention time, see the x-axis in FIG. 3), which together form the coordinates (x, y) of each peak. Each ion pair is composed of the mass-to-charge ratio (m/z) of a precursor ion and the mass-to-charge ratio of a product ion. For example, one ion pair of Iprodione consists of a precursor ion with an m/z of 314 and a product ion with an m/z of 56, thus the ion pair is represented as 314>56. Two other ion pairs of Iprodione are represented as 314>245 and 314>271, respectively.

The reading module 32 can query the compound list 31 to get the name of the compound it has read. For example, if the compound list 31 records one of Iprodione's ion pairs as 314>56, as long as the reading module 32 identifies an ion pair of 314>56 for a certain compound, it can determine that the name of that compound is Iprodione.

The compound list 31 is typically generated along with the mass spectrometry file 5 at the designated location by the mass spectrometer 1 and transmitted to the server 3 by the user computer 2. Furthermore, when the compound list 31 is integrated into the mass spectrometry file 5, the collection module 21 of the user computer 2 only needs to transmit the mass spectrometry file 5. If the compound list 31 is stored separately at the designated location, the collection module 21 needs to transmit both the mass spectrometry file 5 and the compound list 31 to the server 3. In cases where the compound list 31 is stored outside the designated location, it must be manually retrieved from the user computer 2 and then stored in the server 3.

As explained above, each mass spectrometry file 5 produced by the mass spectrometer 1 can be read using the reading module 32. As long as the test solution 4 corresponding to the mass spectrometry file 5 contains compounds, regardless of their quantity, the peaks of each ion pair of each compound can be read by the reading module 32. This applies unless the test solution 4 contains no compounds or contains compounds that are not recorded in the compound list 31. Additionally, the name of each compound can also be retrieved by the reading module 32 through querying the compound list 31.

If there is no need to know the name of each compound, the reading module 32 does not need to query the compound list 31, and the creation of the compound list 31 would not be necessary. However, even in such cases, it is still possible to identify the name of each compound using one of its ion pairs. Since the mass-to-charge ratio (m/z) of each ion pair is unique to a specific compound, the compound can be identified by the m/z of its ion pair. For example, if an ion pair has an m/z of 314>56, it indicates that the ion pair belongs to Iprodione.

Different brands of mass spectrometers 1 often produce mass spectrometry files 5 in different formats. In response to this, server 3 is equipped with a conversion module 33. The conversion module 33 first converts the file format of the mass spectrometry file 5 received by the server 3 into the file format required by the reading module 32, such as the standard formats commonly known for mass spectrometry files: mzData, mzXML, or mzML, with mzML being the preferred format. Regardless of which brand of mass spectrometer 1 generated the mass spectrometry file 5, after the file is transmitted from the client computer 2 to the server 3, the conversion module 33 will convert it into a uniform file format to facilitate the reading module 32 in reading mass spectrometry files 5 produced by different brands of mass spectrometers 1. However, if the file format of the mass spectrometry file 5 produced by the mass spectrometer 1 already matches the format required by the reading module 32, then there is no need for the server 3 to have a conversion module 32, nor is there any need to perform the aforementioned file format conversion process.

Additionally, it is possible for the mass spectrometer 1 to produce multiple mass spectrometry files 5 at once, which are transmitted from the client computer 2 to the server 3, such as a batch of mass spectrometry files 5 corresponding to various test solutions 4. To help the reading module 32 identify which test solution 4 each mass spectrometry file 5 is derived from, the server 3 is also equipped with a checking module 34 to verify whether the name of the mass spectrometry file 5 conforms to a specified naming format. This naming format is preferably composed of a test date code, a test batch code, a test solution type code, a matrix type code, and a concentration code, but is not limited to this structure. For example, for a mass spectrometry file 5 named “24020801PV_200.lcd”, the file extension “.lcd” indicates that the mass spectrometer 1 used to generate it is from Shimadzu. “24020801” indicates that it is one of the mass spectrometry files 5 generated by the mass spectrometer 1 during the testing of the first batch of test solutions 4 on Feb. 8, 2024. “P” indicates that it corresponds to the calibration solution's calibration point mass spectrometry file 53, while “V” and “200” indicate that the matrix contained in the calibration solution is vegetables, and the concentration of the compound (pesticide) standard solution is 200 ppb. For another mass spectrometry file 5 named 24020801LV02Z.lcd, L indicates that it corresponds to the standard mass spectrometry file 51 of the standard comparison solution, and Z indicates that it is the last file in the first batch of mass spectrometry files 5. The ‘02’ between ‘V’ and ‘Z’ indicates that this is the second standard comparison solution, and the remaining codes are the same as previously mentioned, which will not be elaborated further.

The checking module 34 performs a file name format check on the mass spectrometry files 5 received by the server 3 before the conversion module 33 executes the file format conversion process. Only the mass spectrometry files 5 with names that comply with the designated naming format are sent to the conversion module 33. However, this format checking process is not mandatory and can be omitted if necessary.

The server 3 also includes a parameter table 35 and a filtering module 36. The parameter table 35 records filter parameter sets for multiple compounds. These compounds can be the same as those in the compound list 31. For instance, if the compound list 31 records the names and ion pairs of 410 compounds (pesticides) as mentioned earlier, the parameter table 35 must also establish the names and corresponding filter parameter sets for these 410 compounds (pesticides). In other words, each compound has a filter parameter set exclusive to itself, serving as its filtering criteria for the filtering module 36 to utilize.

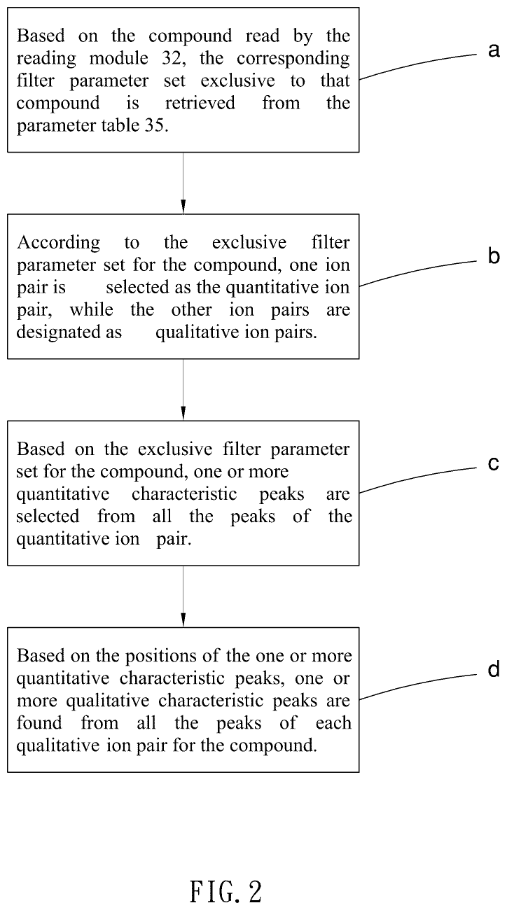

The filtering module 36 performs a filtering operation on the ion pairs and their peaks of each compound, as read by the reading module 32, based on the parameter table 35. Refer to FIG. 2 for this process. The filtering operation includes the following one or more steps:
a) Based on the compound read by the reading module 32, the corresponding filter parameter set exclusive to that compound is retrieved from the parameter table 35.
b) According to the exclusive filter parameter set for the compound, one ion pair is selected as the quantitative ion pair, while the other ion pairs are designated as qualitative ion pairs (Note: typically, there is only one quantitative ion pair, but the number of qualitative ion pairs is at least one, usually two, or even more).
c) Based on the exclusive filter parameter set for the compound, one or more quantitative characteristic peaks are selected from all the peaks of the quantitative ion pair.
d) Based on the positions of the one or more quantitative characteristic peaks, one or more qualitative characteristic peaks are found from all the peaks of each qualitative ion pair for the compound.

From the above explanation, it is clear that the mass spectrometry data of each compound, as read by the reading module 31, can be filtered by the filtering module 36, regardless of which mass spectrum file 5 the data was read from. This allows for the retrieval of each compound's quantitative ion pair, quantitative characteristic peak, qualitative ion pair, and qualitative characteristic peak. For example, if the aforementioned LC standard comparison solution contains 216 pesticide standards, including Abamectin, the reading module 31 can read the mass spectrometry data of these 216 pesticides from the corresponding LC standard mass spectrometry file. The filtering module 36 can then filter this data to obtain the quantitative ion pairs, quantitative characteristic peaks, qualitative ion pairs, and qualitative characteristic peaks for these 216 pesticides.

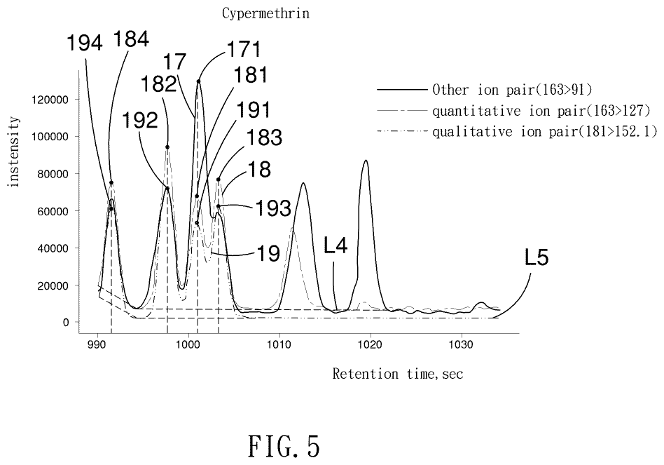

The server 3 is also equipped with a spectrum plotting module 37 for generating mass spectrograms. More specifically, the spectrum plotting module 37 is designed to plot the quantitative ion pair curve and each qualitative ion pair curve for each compound, based on all the peaks of the quantitative ion pair and qualitative ion pairs filtered by the filtering module 36. For example, as shown in FIG. 3, the spectrogram for Iprodione includes a quantitative ion pair curve 11 and two qualitative ion pair curves 12 and 13; FIG. 4 shows the spectrogram for Allethrin, which includes a quantitative ion pair curve 14 and two qualitative ion pair curves 15 and 16; and FIG. 5 shows the spectrogram for Cypermethrin, which includes a quantitative ion pair curve 18 and a qualitative ion pair curve 19.

The mass spectrometry plot drawing module 37 can also label the quantitative characteristic peaks and qualitative characteristic peaks, as filtered by the filtering module 36, on the aforementioned mass spectrometry plots. For example: FIG. 3 shows the quantitative characteristic peak 111 of Iprodione's quantitative ion pair, along with the qualitative characteristic peaks 121 and 131 for each qualitative ion pair; FIG. 4 shows two quantitative characteristic peaks 141 and 142 of Allethrin's quantitative ion pair, as well as two qualitative characteristic peaks 151 and 152 for one qualitative ion pair, and two qualitative characteristic peaks 161 and 162 for another qualitative ion pair; FIG. 5 shows four quantitative characteristic peaks 181-184 for Cypermethrin's quantitative ion pair, and four qualitative characteristic peaks 191-194 for the qualitative ion pair.

In the parameter table 35, some compounds have the same filter parameter sets, while others have different ones. Regardless, each compound's filter parameter set includes one or more of the following parameters: a smoothing parameter, a select parameter, the quantity parameter, a position parameter, a re-selection parameter, a deletion parameter, a peak ratio parameter, a signal-to-noise ratio parameter, and a signal-to-noise ratio judgment parameter. Some of these parameters are needed by the filtering module 36 during the execution of the aforementioned filtering process (see steps c and d), while others are required by other modules that will be mentioned later.

Preferably, for each ion pair peak read by the reading module 32, the filtering module 36 can determine the extent of smoothing to be applied to the coordinate points of each ion pair peak based on the smoothing parameter. This helps to filter out some peaks caused by noise, ensuring that the quantitative ion pair curve and the qualitative ion pair curve drawn by the mass spectrogram drawing module 37 are as smooth as possible. For example, when the smoothing parameter is a null value (NULL), it indicates that the filtering module 36 does not apply any smoothing. When the smoothing parameter is a numerical value, the larger the value, the greater the extent of smoothing applied by the filtering module 36, and vice versa for smaller values.

In the aforementioned step b, the filtering module 36 can select the ion pair with the highest or lowest peak as the quantitative ion pair for the compound, based on the select parameter. For example, if the value of the select parameter is a first value (e.g., null), the ion pair with the highest peak is selected as the compound's quantitative ion pair. If the value of the select parameter is a second value (e.g.,−1), the ion pair with the lowest peak is selected as the compound's quantitative ion pair.

For example, if the select parameter for the quantitative ion pair of Iprodione is read by the filtering module 36 from the parameter table 35 and its value is the first value, the first ion pair (314>56) of Iprodione is selected as its quantitative ion pair because, as shown in FIG. 3, among the three curves 11-13, the one with the highest quantitative characteristic peak 111 is the first ion pair (314>56). The other two ion pairs (314>245 and 314>271) are selected as the qualitative ion pairs for Iprodione. Similarly, as shown in FIG. 4, the first ion pair (123>81) with the highest quantitative characteristic peak 141 is selected as the quantitative ion pair for Allethrin, while the other two ion pairs (107>91 and 136>93) are selected as the qualitative ion pairs for Allethrin.

However, if the select parameter for the quantitative ion pair of Cypermethrin read from the parameter table 35 by the filtering module 36 is the second value, the third ion pair of Cypermethrin (181>152.1) will be temporarily treated as the quantitative ion pair of Cypermethrin, and the other two ion pairs (163>91 and 63>127) will be temporarily treated as two qualitative ion pairs. Thus, as shown in FIG. 5, 163>127 is Cypermethrin's quantitative ion pair, 181>152.1 is Cypermethrin's qualitative ion pair, and the quantitative ion pair signal curve and qualitative ion pair signal curve correspond to FIG. 18 and FIG. 19, respectively. Although signal curve 17 has the highest peak 171, it only represents one of Cypermethrin's ion pairs (163>91) and is neither the quantitative ion pair signal curve nor the qualitative ion pair signal curve.

In the aforementioned step c, the filtering module 36 determines the number of quantitative characteristic peaks for the compound based on the quantity parameter. For instance, if the quantity parameter is null or 1, the filtering module 36 selects the peak with the highest intensity (i.e., rank 1) from all peaks of the quantitative ion pair for the compound, designating it as the sole quantitative characteristic peak. If the quantity parameter is 2, the filtering module 36 selects the top 2 peaks (i.e., ranks 1 and 2) as the two quantitative characteristic peaks for the quantitative ion pair of the compound. Similarly, if the quantity parameter is 3, the filtering module 36 selects the top 3 peaks (i.e., ranks 1 to 3) as the three quantitative characteristic peaks for the quantitative ion pair of the compound, and so on.

For example, if the filtering module 36 retrieves a value of null for the quantity parameter of Iprodione from the parameter table 35, as shown in FIG. 3, the highest peak 111, which ranks first among all peaks of the quantitative ion pair (314>56) of Iprodione, is selected as the sole quantitative characteristic peak of Iprodione's quantitative ion pair (314>56). If the filtering module 36 retrieves a value of 2 for the quantity parameter of Allethrin from the parameter table 35, as shown in FIG. 4, although peaks 141-143 of Allethrin's quantitative ion pair (123>81) are all prominent, only the top 2 peaks, 141 and 142, are selected as the two quantitative characteristic peaks for Allethrin's quantitative ion pair (123>81) based on the quantity parameter. If the filtering module 36 retrieves a value of 4 for Cypermethrin's quantity parameter from the parameter table 35, as shown in FIG. 5, the top 4 peaks, 191-194, from Cypermethrin's quantitative ion pair (181>152.1, temporary) are selected as the four temporary quantitative characteristic peaks for Cypermethrin.

In the aforementioned step d, the filtering module 36 can define an allowable position range for each of the quantitative characteristic peaks based on the position parameter, and peaks whose positions fall within this allowable range, from ion pairs other than the quantitative ion pair (i.e., qualitative ion pairs), are selected as the compound's qualitative characteristic peaks. For example, if the position parameter is NULL or 1, the allowable position range for each quantitative characteristic peak is within 1 second before and after its position. If the position parameter is 1.5, the range extends to 1.5 seconds before and after the position of each quantitative characteristic peak. If the position parameter is 2, the allowable range is 2 seconds before and after, and so on.

For example, in FIG. 3, the position of Iprodione's quantitative characteristic peak (i.e., the highest peak 111) is t1. If the value of Iprodione's position parameter that the filtering module 36 read from the parameter table is 1, the allowable position range for peak 111 is between t1−1 and t1+1. Next, by tracing down from the quantitative characteristic peak 111 along a dashed line passing through position t1(a virtual line that does not exist in the mass spectrum), the peak 121 at position t1, as well as the peak 131 near position t1, can be found. Since both of these peaks 121 and 131 fall within the allowable position range of quantitative characteristic peak 111, the filtering module 36 selects them as Iprodione's two qualitative characteristic peaks, 121 and 131. Thus, a total of three characteristic peaks are obtained for Iprodione: one quantitative characteristic peak 111 and two qualitative characteristic peaks 121 and 131.

Similarly, the filtering module 36 can identifies Allethrin's qualitative characteristic peaks based on the positions of its two quantitative characteristic peaks, 141 and 142. As shown in FIG. 4, peaks 151 and 152 correspond to the positions of the two quantitative characteristic peaks 141 and 142, so the filtering module 36 designates them as the two qualitative characteristic peaks for one of Allethrin's qualitative ion pairs (107>91). Additionally, peaks 161 and 162 are still within the allowable position range of quantitative characteristic peaks 141 and 142, so the filtering module 36 designates them as the two qualitative characteristic peaks for Allethrin's other qualitative ion pair (136>93). Thus, a total of six characteristic peaks are obtained for Allethrin: two quantitative characteristic peaks 141 and 142, and four qualitative characteristic peaks 151, 152, 161, and 162.

Similarly, the filtering module 36 can identifies the qualitative characteristic peaks (temporary) of Cypermethrin based on the positions of its four quantitative characteristic peaks 191 to 194 (temporary). As shown in FIG. 5, by tracing up along the dashed lines through the quantitative characteristic peaks 191 to 194, peaks 181 to 184 can be found on one of Cypermethrin's qualitative ion pair curves (163>127), and they are temporarily designated as the four qualitative characteristic peaks of this qualitative ion pair. Then, the filtering module 36 performs the aforementioned swapping operation to obtain eight characteristic peaks for Cypermethrin, namely, the four quantitative characteristic peaks 181 to 184 and the four qualitative characteristic peaks 191 to 194.

As described above, the filtering module 36 of this invention can indeed obtain the characteristic peaks of each ion pair of one or more compounds from any mass spectrometry file 5. The number of characteristic peaks for each ion pair can be one, two, or more.

In the aforementioned step c, for some compounds, the filtering module 36 may find peaks based on the quantity parameter (i.e., the peaks that rank in the top N in height). However, it may not be appropriate to treat all of them as quantitative characteristic peaks. In response to this, the filtering operation executed by the filtering module 36 may further include: determining, based on the re-selection parameter, whether to retain all the top N peaks as the compound's quantitative characteristic peaks, or to reselect the peak ranked at position M among the top N peaks as the compound's quantitative characteristic peak, where M is determined by the re-select parameter. For example, when the value of the re-selection parameter is NULL, M is also NULL, and all the top N peaks are designated as the compound's quantitative characteristic peaks. However, if the re-selection parameter is not NULL, the peak ranked at position M among the top N peaks is designated as the compound's quantitative characteristic peak. For instance, if the value of the re-selection parameter is 1, M equals 1, and the peak ranked first among the top N peaks is designated as the compound's sole quantitative characteristic peak. If the value of the re-selection parameter is 2, M equals 2, and the peak ranked second among the top N peaks is designated as the sole quantitative characteristic peak, and so on. Assuming the value of Cypermethrin's re-selection parameter read from the parameter table is 2, as shown in FIG. 4, the second peak from the left among the top four peaks 191 to 194 is peak 192, so only peak 192 is temporarily designated as Cypermethrin's sole quantitative characteristic peak.

Considering that the highest peak of the quantitative ion pair of some compounds may coincidentally be the first or last peak in terms of position, this means that the starting or ending point of the quantitative ion pair curve for these compounds could be the highest peak. If this is the case, during step c, the filtering module 36 may mistakenly identifies the first or last peak as one of the compound's quantitative characteristic peaks, which would be incorrect. To avoid this error, the filtering operation executed by the filtering module 36 may further include: deleting the first and last peaks of all the peaks in the compound's quantitative ion pair based on the deletion parameter, and then proceeding with step c. For example, when the deletion parameter has a first value (e.g., NULL), the first and last peaks of the compound's quantitative ion pair are deleted, and then step c is continued. However, when the deletion parameter has a second value (e.g.,−1), it indicates that no peaks should be deleted. Additionally, if the quantity parameter is ≥2, no peaks need to be deleted (i.e., the deletion parameter can be ignored)

In step b, considering that some compounds' quantitative ion pairs, after being selected, may require further evaluation to determine if they are qualified, the filtering operation executed by the filtering module 36 may further include: determining whether the value of the compound's quantity parameter is greater than or equal to 2. If the result is “yes,” a qualification judgment operation is performed on the compound's quantitative ion pair based on the compound's peak ratio parameter. This qualification judgment operation includes: dividing the height of the first-ranked quantitative characteristic peak by the height of each subsequent quantitative characteristic peak to obtain one or more height ratios; determining whether each height ratio is greater than the peak ratio parameter; and if the result is “yes,” designating the quantitative ion pair as a qualified ion pair, otherwise, designating it as an unqualified ion pair.

As explained above, the filtering module 36 uses the filtering conditions defined by each compound's own filter parameter set to select the quantitative ion pair and the quantitative characteristic peaks for each compound. Based on the selected quantitative characteristic peaks, it then identifies the qualitative characteristic peaks, thereby significantly improving the accuracy of the obtained quantitative and qualitative characteristic peaks. Furthermore, the parameter table 35 is created specifically for the mass spectrometer 1 that generated the mass spectrometry files 5. In other words, for different brands of mass spectrometers 1, or even for the same model used by different users, dedicated parameter tables 35 can be created on the server 3. This approach fully integrates the characteristics of the instrument, and even the user's operational habits, thus further enhancing the accuracy of the obtained quantitative and qualitative characteristic peaks. In fact, in the aforementioned step a, the filtering module 36 determines which parameter table 35 to use based on the identity information received by the server 3.

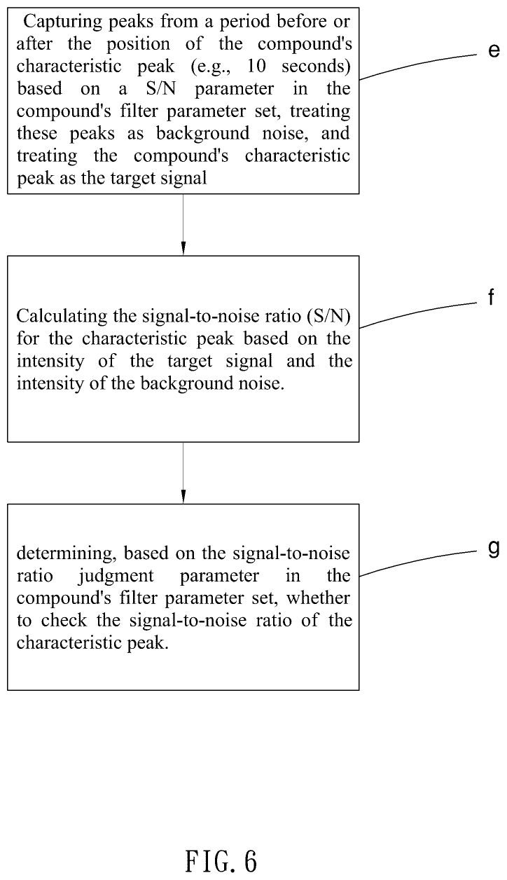

Preferably, the server 3 also includes a signal-to-noise ratio (S/N) calculation module 38, which is used to calculate the signal-to-noise ratio (S/N) of the quantitative characteristic peaks and/or the qualitative characteristic peaks for each compound. The S/N for each quantitative or qualitative characteristic peak is the ratio of the signal intensity of each quantitative or qualitative characteristic peak to the signal intensity of the background noise near it. More preferably, the S/N calculation module 38 can perform an S/N calculation operation, as shown in FIG. 6, which can be executed after the aforementioned step c or d, and includes the following steps:
e) Capturing peaks from a period before or after the position of the compound's characteristic peak (e.g., 10 seconds) based on a S/N parameter in the compound's filter parameter set, treating these peaks as background noise, and treating the compound's characteristic peak as the target signal, where the characteristic peak can be either a quantitative or qualitative characteristic peak; and
f) Calculating the signal-to-noise ratio (S/N) for the characteristic peak based on the intensity of the target signal and the intensity of the background noise.

Preferably, the method for calculating the signal-to-noise ratio may further include:
g) Determining, based on the signal-to-noise ratio judgment parameter in the compound's filter parameter set, whether to check the signal-to-noise ratio of the characteristic peak. For any compound, the signal-to-noise ratio of a quantitative characteristic peak typically must be greater than or equal to 10 to be considered qualified; otherwise, it is considered unqualified. For any compound, the signal-to-noise ratio of a qualitative characteristic peak typically must be greater than or equal to 2 to be considered qualified; otherwise, it is considered unqualified.

Preferably, the server 3 also includes an area calculation module 39 to perform an area calculation operation. This operation calculates the total area of a characteristic peak for each compound and the area ratio for each compound. The total area of each compound's characteristic peak can be calculated using the composite trapezoidal rule, but is not limited to this method. The characteristic peak can be a quantitative characteristic peak or a qualitative characteristic peak. The area ratio of each compound is defined as the ratio between the total area of the qualitative characteristic peaks and the quantitative characteristic peaks. The area calculation operation at least includes setting a baseline for a characteristic peak (as shown in FIGS. 3 to 5, L1 to L5) and using the trapezoidal rule to calculate the total area between the characteristic peak and the baseline. The baseline is drawn as the connection between the lowest points on either side of the characteristic peak, which serves as the reference for the mass spectrometry graph rendering module 37 to draw the baseline. In this implementation, the area calculation module 39 sets one baseline for each compound's quantitative and qualitative characteristic peaks, respectively. As shown in FIG. 3, since the lowest points of Iprodione's quantitative ion pair curve 11 and qualitative ion pair curve 12 overlap, the mass spectrometry graph rendering module 37 can only draw one baseline, L1. In FIGS. 4 and 5, the mass spectrometry graph rendering module 37 can draw separate baselines for Allethrin's quantitative ion pair curve 14 and qualitative ion pair curve 15 as L2 and L3, and for Cypermethrin's quantitative ion pair curve 18 and qualitative ion pair curve 19 as L4 and L5. It should also be noted that the area calculation operation can be executed after the aforementioned steps c, d, f, or g.

As described above, for each compound, regardless of which type of mass spectrometry file 5 it originates from, the server 3 can use the data reading module 32 to retrieve its mass spectrometry data, and utilize the filtering module 36 to identify its quantitative and qualitative ion pairs as well as their quantitative and qualitative characteristic peaks. Additionally, the mass spectrometry graph drawing module 37 can be used to plot the corresponding mass spectrometry graphs.

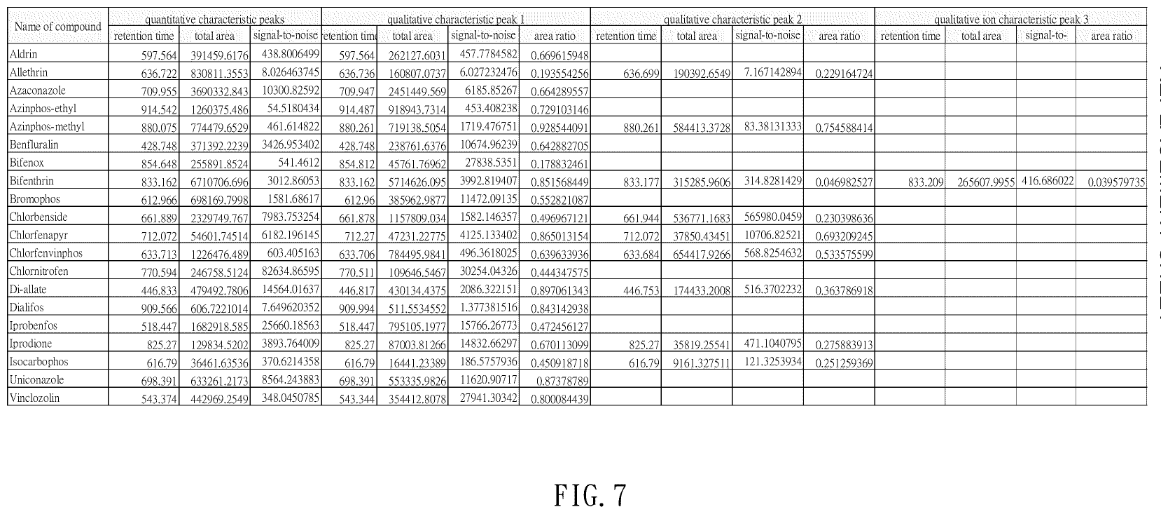

Additionally, for each compound, the server 3 can utilize the signal-to-noise ratio (S/N) calculation module 38 to compute the S/N of its quantitative and qualitative characteristic peaks, and use the area calculation module 39 to calculate the total area of its quantitative characteristic peaks and qualitative characteristic peaks, as well as their area ratio. The calculated characteristic peak data for each compound can be stored by the server 3 in a characteristic peak ion file (e.g., EXCEL). FIG. 7 illustrates the characteristic peak data for some compounds derived from the standard mass spectrometry file 51, wherein the “retention time” column refers to the position of the highest quantitative or qualitative characteristic peak

For the mass spectrometry data read by the reading module 32 for each compound, regardless of which mass spectrometry file 5 the data is read from, the server 3 can use the filtering module 36 to obtain the quantitative and qualitative data for each compound. This quantitative and qualitative data includes the quantitative ion pair, quantitative characteristic peaks, at least one qualitative ion pair, and at least one qualitative characteristic peak. In summary, for each mass spectrometry file 5, the server 3 uses the filtering module 36 to retrieve the aforementioned quantitative and qualitative data. However, an alternative approach is that only the quantitative and qualitative data from compounds in a specific mass spectrometry file 5 (e.g., the standard mass spectrometry file 51) are obtained using the filtering module 36, while the quantitative and qualitative data from compounds in other mass spectrometry files 5 (e.g., the aforementioned sample mass spectrometry file 52 and calibration point mass spectrometry file 53) are obtained using the characteristic peak extraction module 40 of the server 3.

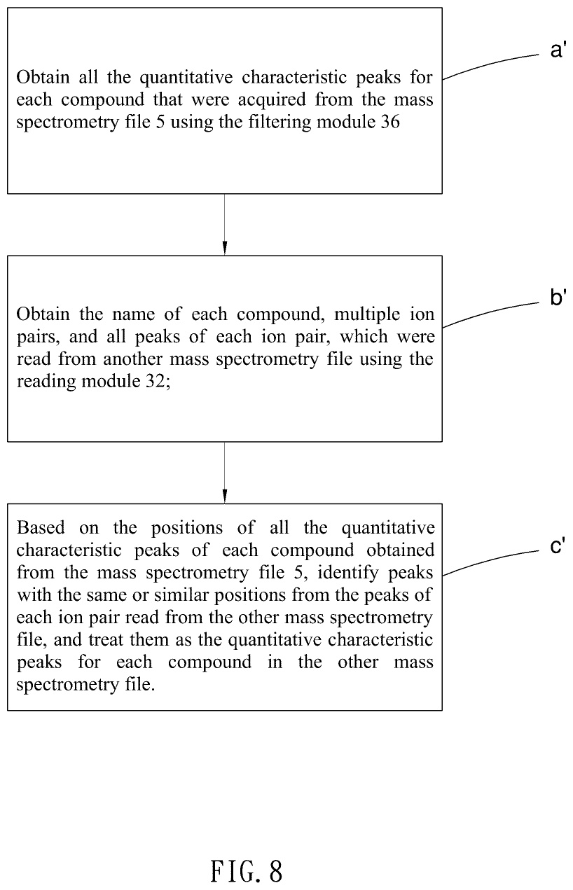

The characteristic peak extraction module 40 is used to perform an extraction operation, as shown in FIG. 8. This extraction operation includes the following steps:
a′) Obtain all the quantitative characteristic peaks for each compound that were acquired from the mass spectrometry file 5 using the filtering module 36;
b′) Obtain the name of each compound, multiple ion pairs, and all peaks of each ion pair, which were read from another mass spectrometry file using the reading module 32;
c′) Based on the positions of all the quantitative characteristic peaks of each compound obtained from the mass spectrometry file 5, identify peaks with the same or similar positions from the peaks of each ion pair read from the other mass spectrometry file, and treat them as the quantitative characteristic peaks for each compound in the other mass spectrometry file.

The qualitative characteristic peaks of each compound from the other mass spectrometry file can also be obtained using the aforementioned steps a′ to c′. However, the qualitative characteristic peaks of each compound from the other mass spectrometry file can alternatively be obtained using the previously mentioned step d.

The term “same or similar position” refers to a deviation within a certain time range (e.g., ±3 seconds). For example, when the position of one of Allethrin's quantitative characteristic peaks from the mass spectrometry file 5 (e.g., the standard mass spectrometry file 51) is at time t, three peaks at position t from Allethrin's three ion pairs in another mass spectrometry file (e.g., the sample mass spectrometry file 52) are identified. The peak with the highest intensity among these three is designated as one of Allethrin's quantitative characteristic peaks for the quantitative ion pair, and the other two peaks are designated as one of the qualitative characteristic peaks for each of Allethrin's two qualitative ion pairs. However, if no such peaks are found, the search is extended to the time range t−3 to t+3, and the identified peaks are then designated as the aforementioned quantitative and qualitative characteristic peaks. Other quantitative and qualitative characteristic peaks of Allethrin from the second mass spectrometry file can be found using this method. Similarly, the quantitative and qualitative characteristic peaks of other compounds from another mass spectrometry file can also be identified using this method.

After the quantitative and qualitative data of each compound from the other mass spectrometry file are obtained by the server 3, the mass spectrometry plot generation module 37 can generate the mass spectrometry plot for each compound based on the total peaks of the quantitative ion pair and the qualitative ion pair from the other mass spectrometry file. As previously mentioned, the coordinate points of the quantitative characteristic peaks and qualitative characteristic peaks for each compound from the other mass spectrometry file can also be marked on the generated mass spectrometry plot. Additionally, the S/N calculation module 38 and the area calculation module 39 can calculate the characteristic peak data for each compound based on the quantitative characteristic peaks and qualitative characteristic peaks obtained from the other mass spectrometry file.

For example, if the mass spectrometry file in step a′ is the aforementioned standard mass spectrometry file 51, since the standard comparison solution corresponding to the standard mass spectrometry file 51 contains the previously mentioned 216 pesticide standards, the server 3 can use the reading module 32 and the filtering module 36 to obtain the quantitative and qualitative data of each pesticide standard from the standard mass spectrometry file 51. The mass spectrometry plot generation module 37 can then generate the mass spectrometry plots for each pesticide standard, and the S/N calculation module 38 and area calculation module 39 can produce the characteristic peak data for each pesticide standard. In the past, when this process was done manually, it required significant professional manpower and time, resulting in low overall efficiency for pesticide testing. Now, these data can be quickly obtained through the automated processes of the server 3, saving considerable time and effort while significantly improving the overall efficiency of pesticide testing.

If the other mass spectrometry file in step b′ is the sample mass spectrometry file 52, the server 3 can quickly obtain the quantitative characteristic peaks and qualitative characteristic peaks of each pesticide from the sample mass spectrometry file 52 using the characteristic peak extraction module 40, without the need to read and use the parameters from the parameter table 35 to execute related operations, thus saving a significant amount of time. Furthermore, after this step, the server 3 can use the mass spectrometry plot generation module 37 to generate the mass spectrometry plots for each pesticide from the sample mass spectrometry file 52, and use the S/N calculation module 38 and the arca calculation module 39 to produce the characteristic peak data for each pesticide. In the past, performing these tasks manually clearly required considerable professional manpower and time; now, these data can be quickly obtained through the automated processing provided by the server 3, which not only saves time and effort but also further improves the overall efficiency of pesticide testing.

Similarly, the server 3 can quickly obtain the quantitative and qualitative data, quantitative characteristic peaks, mass spectrometry plots, and characteristic peak data for each compound (pesticide) from various calibration mass spectrometry files 53 and use them to generate a calibration curve for each compound (pesticide) standard. For example, seven calibration solutions with different concentrations can be prepared, containing standard solution concentrations of 2, 5, 10, 20, 50, 100, and 200 ppb. The server 3 can use the data extraction module 32, filtering module 36, and peak extraction module 40 to retrieve the quantitative and qualitative data for each compound standard from the corresponding calibration mass spectrometry files 53, and use the S/N calculation module 38 and area calculation module 39 to generate the characteristic peak data for each compound standard. Then, based on the total area of the quantitative characteristic peaks of the quantitative ion pairs from the calibration solutions and the known concentrations, the server 3 can generate a calibration curve for each compound, along with its coefficient of determination R2, slope a, and intercept b. Each calibration curve consists of seven calibration points, with the x-values representing the seven known concentrations, and the y-values corresponding to the total area of the quantitative characteristic peaks for each known concentration. However, if the server 3 detects one or two outliers among the seven calibration points, it can exclude them, which will reduce the number of calibration points to five, but the generated calibration curve will still comply with the minimum requirement of containing five calibration points as stipulated by the official guidelines.

Similarly, the server 3 can also quickly retrieve the quantitative and qualitative data, quantitative characteristic peaks, mass spectrometry plots, and characteristic peak data for each compound (pesticide) from the quality control mass spectrometry files. These data can then be used to generate a quality control chart for each compound (pesticide) standard. Likewise, the server 3 can quickly retrieve the quantitative and qualitative data, quantitative characteristic peaks, mass spectrometry plots, and characteristic peak data for each compound (pesticide) from the instrument management mass spectrometry files and use these to generate an instrument management table, which records the instrument management data for each pesticide standard.

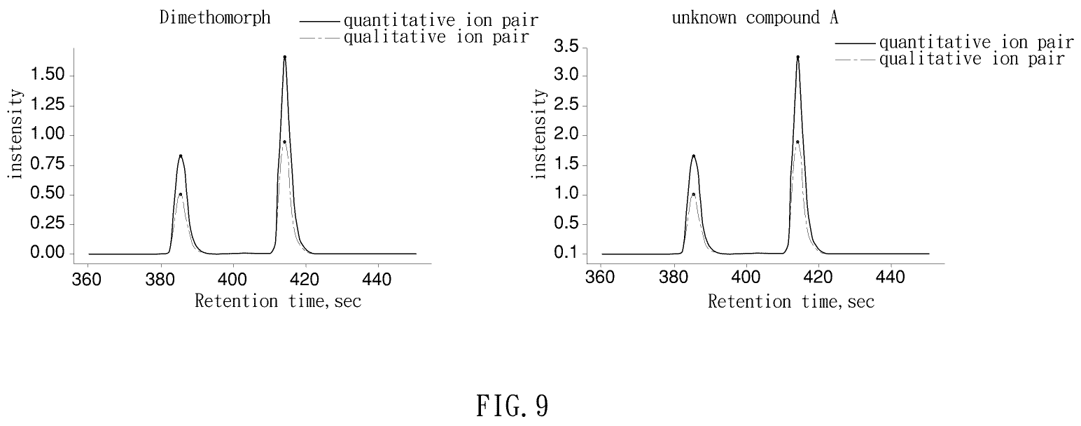

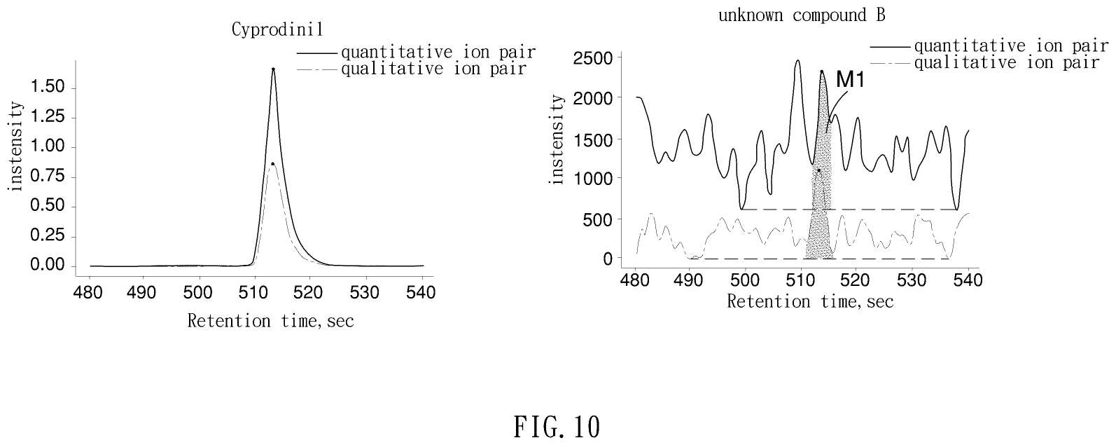

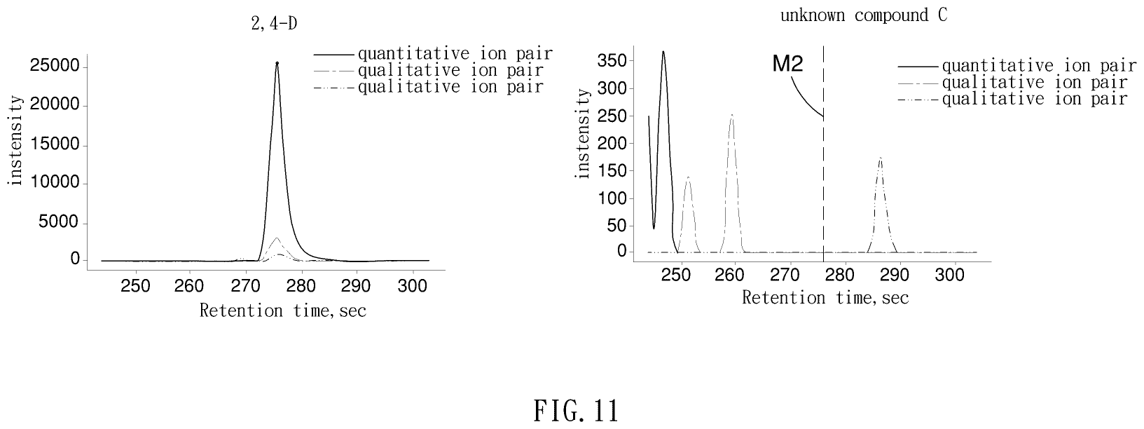

Preferably, the server 3 also includes a mass spectrometry comparison module 41 designed to compare the characteristic peaks of the same compound from one mass spectrometry file (e.g., the standard mass spectrometry file 51) with those from another mass spectrometry file (e.g., the sample mass spectrometry file 52). If the compared characteristic peaks have the same retention time, signal-to-noise ratio (S/N), and area ratio, the server 3 determines that the compound has been detected in the second mass spectrometry file based on the comparison. Conversely, if any of these values differ, the server 3 determines that the compound is not detected in the second mass spectrometry file. In such cases, the mass spectrometry plot generation module 37 will annotate the mass spectrometry plot for that compound in the second mass spectrometry file by adding a first marker M1 (e.g., a gray shading, see FIG. 10) at the compound's highest characteristic peak. If the compound is not found in the second mass spectrometry file, indicating that it was not added to the corresponding test solution, the mass spectrometry plot generation module 37 will add a second marker M2 (e.g., a vertical dashed line, see FIG. 11) at the expected location of the characteristic peak. For example, FIGS. 9 to 11 show mass spectrum comparison charts of three compounds generated by the mass spectrometry plot generation module 37. The mass spectra of three known compounds derived from the mass spectrum file (for example, the standard mass spectrometry file 51) are shown on the left side of FIGS. 9 to 11, which are Dimethomorph, Cyprodinil, and 2,4-D (2,4-Dichlorophenoxyacetic acid), respectively. The right side of FIG. 9 shows the mass spectrum of an unknown compound A derived from another mass spectrometry file (for example, the sample mass spectrometry file 52). Since the mass spectrometry comparison module 41 found that the characteristic peaks of the unknown compound A match those of Dimethomorph (i.e., the positions, signal-to-noise ratios, and area ratios of the characteristic peaks for the two compounds are the same), it concludes that the unknown compound A is Dimethomorph. Subsequently, the mass spectrometry plot generation module 37 generates the mass spectra for both Dimethomorph and the unknown compound A based on this conclusion, displaying them side by side, and it is preferable to highlight the characteristic peaks of the unknown compound A in color. The right side of FIG. 10 shows the mass spectrum of an unknown compound B derived from another mass spectrometry file (for example, the sample mass spectrometry file 52). Although the mass spectrometry comparison module 41 found that the characteristic peaks of the unknown compound B and Cyprodinil match in position, the difference in their signal-to-noise ratios led the module to conclude that the unknown compound B is not Cyprodinil. Subsequently, the mass spectrometry plot generation module 37 generates the mass spectra for both Cyprodinil and the unknown compound B based on this conclusion, displaying them side by side, and preferably labeling the characteristic peak of the unknown compound B with the first marker M1.

The right side of FIG. 11 shows the mass spectrum of an unknown compound C derived from another mass spectrometry file (for example, the sample mass spectrometry file 52). The mass spectrometry comparison module 41 compared the characteristic peak positions of 2,4-D (2,4-Dichlorophenoxyacetic acid) with those of the unknown compound C and found that there are no peaks at those positions, let alone characteristic peaks. This indicates that the unknown compound C is not present in the mass spectrometry file (the standard mass spectrometry file 51). Therefore, the mass spectrometry comparison module 41 concludes that the unknown compound C is not 2,4-D and does not exist in that mass spectrometry file. Subsequently, the mass spectrometry plot generation module 37 generates the mass spectra for both 2,4-D and the unknown compound C based on this conclusion, displaying them side by side, and preferably labeling the position of the unknown compound C with a second marker M2.

After the server 3 obtains the characteristic peak data of compounds from a mass spectrometry file using filtering module 36 or other methods, the characteristic peak extraction module 40 can use the positions of the characteristic peaks in the characteristic peak data of compounds to compare and calculate against the mass spectrometry data from another mass spectrometry file, thereby obtaining the characteristic peak data for each compound in that other mass spectrometry file, wherein the mass spectrometry data of another mass spectrometry file can be obtained through the reading module 32. As for the mass spectrometry comparison module 41, it is configured to compare the characteristic peak data of compounds from one mass spectrometry file with the characteristic peak data of compounds from another mass spectrometry file. If the two compounds being compared have the same characteristic peak data, it indicates that they are the same compound; otherwise, they are different compounds.

In one example, the “modules” mentioned above may be software (e.g., application, program, operational instructions, etc.) running on one or more processing devices. The processing device may be a server, personal computer, smartphone, tablet, laptop, personal digital assistant (PDA) and/or any other electronic devices.

1. A compound mass spectrometry analysis system, comprising a mass spectrometer, a client computer coupled to the mass spectrometer, and a server coupled to the client computer; wherein the mass spectrometer is configured to analyze a test solution and generate a corresponding mass spectrometry file on the client computer, the client computer is configured to transmit the mass spectrometry file to the server, and the server includes a reading module, wherein the reading module is configured to read a plurality of ion pairs of each compound contained in the test solution and all corresponding peaks of each ion pair from the mass spectrometry file.

2. The compound mass spectrometry analysis system as recited in claim 1, wherein the server further includes a compound list that records the names and ion pairs of multiple compounds, and the reading module is able to, based on the ion pair of each compound read from the mass spectrometry file, query the compound list to obtain the name of each compound in the mass spectrometry file.

3. The compound mass spectrometry analysis system as recited in claim 1, wherein the server further includes a conversion module, and the conversion module is configured to perform a file format conversion operation, which includes converting the file format of the mass spectrometry file received by the server into the file format required by the reading module.

4. The compound mass spectrometry analysis system as recited in claim 3, wherein the server further includes a checking module, and the checking module performs a format checking operation on the name of the mass spectrometry file received by the server before the conversion module executes the file format conversion operation, and the format checking operation only transmits mass spectrometry files with names that conform to a naming format to the conversion module.

5. The compound mass spectrometry analysis system as recited in claim 1, wherein the server further includes a parameter table and a filtering module, the parameter table records filter parameter sets for a plurality of compounds, and the filtering module performs a filtering operation on the ion pairs and peaks of each compound read by the reading module based on the parameter table, wherein the filtering operation comprises:
reading the filter parameter set of a compound from the parameter table based on the compound read by the reading module; and
based on the filter parameter set of the compound, selecting one of the ion pairs read by the reading module as a quantitative ion pair of the compound, and designating the remaining ion pairs as qualitative ion pairs of the compound.

6. The compound mass spectrometry analysis system as recited in claim 5, wherein the filtering operation includes:
based on the filter parameter set of the compound, selecting one or more peaks from all the peaks of the quantitative ion pair of the compound as one or more quantitative characteristic peaks of the quantitative ion pair.

7. The compound mass spectrometry analysis system as recited in claim 6, wherein the filtering operation includes:
based on the positions of the one or more quantitative characteristic peaks, respectively identifying one or more peaks with same positions as the one or more quantitative characteristic peaks, from all the peaks of each qualitative ion pair of the compound, and using them as the one or more qualitative characteristic peaks for each qualitative ion pair.

8. The compound mass spectrometry analysis system as recited in claim 5, wherein the parameter table is created for the mass spectrometer, and the client computer includes a collection module configured to transmit the mass spectrometry file and an identification data of the client computer to the server, wherein the filtering module is able to identify the parameter table based on the identification data.

9. The compound mass spectrometry analysis system as recited in claim 7, wherein the server further includes a signal-to-noise ratio (S/N) calculation module for performing an S/N calculation operation, which comprises the following steps:
based on a S/N parameter of the filter parameter set of the compound, capturing peaks from a period before or after the position of the quantitative or qualitative characteristic peak as a background noise, and treating the quantitative or qualitative characteristic peak as a target signal; and
calculating the S/N for the quantitative or qualitative characteristic peak based on the intensity of the target signal and the intensity of the background noise.

10. The compound mass spectrometry analysis system as recited in claim 9, wherein the signal-to-noise ratio (S/N) calculation operation further comprises the following step:
determining, based on the S/N judgment parameter of the filter parameter set of the compound, whether to check the S/N of the quantitative or qualitative characteristic peak.

11. The compound mass spectrometry analysis system as recited in claim 7, wherein the server further includes an area calculation module for performing an area calculation operation, which comprises:
establishing a baseline for the quantitative or qualitative characteristic peak, wherein the baseline is the line connecting the lowest points on both side of the quantitative or qualitative characteristic peak; and
calculating the total area between the quantitative or qualitative characteristic peak and the baseline.

12. The compound mass spectrometry analysis system as recited in claim 6, wherein the server further includes a characteristic peak extraction module for performing an extraction operation, the extraction operation comprising the following steps:
obtaining all quantitative characteristic peak of each compound acquired from the mass spectrometry file via the filtering module;
obtaining the names of each compound, multiple ion pairs of each compound, and all peaks for each ion pair, which were read from another mass spectrometry file via the reading module; and
based on the positions of all quantitative characteristic peaks of each compound acquired from the mass spectrometry file, identifying peaks with the same or similar positions from all peaks of each ion pair of each compound read from the other mass spectrometry file, and designating them as quantitative characteristic peaks of each compound read from the another mass spectrometry file.

13. The compound mass spectrometry analysis system as recited in claim 7, wherein the server further includes a mass spectrum plotting module, which is configured to plot a mass spectrum for each compound based on all peaks of the quantitative ion pair and one or more qualitative ion pairs of each compound filtered by the filtering module, wherein each mass spectrum includes a quantitative ion pair curve and one or more qualitative ion pair curves for each compound, and the mass spectrum plotting module is further configured to mark the coordinate points of the quantitative characteristic peaks and the qualitative characteristic peaks of each compound on the mass spectrum based on the height and position of the quantitative characteristic peaks and qualitative characteristic peaks of each compound filtered by the filtering module.

14. The compound mass spectrometry analysis system as recited in claim 7, wherein the server further includes a mass spectrum comparison module, which is configured to compare whether the quantitative characteristic peak (or qualitative characteristic peaks) from one mass spectrometry file is same as the quantitative characteristic peak (or qualitative characteristic peaks) from another mass spectrometry file.

15. A server in the compound mass spectrometry analysis system as recited in claim 1.
